(19) United States
(12) Patent Application Publication
(10) Pub. No.: US 2015/0088271 A1
(43) Pub. Date: Mar. 26, 2015

(54) METHOD OF AUTOMATED PROCESSING OF TASKS

(71) Applicant: Pierre TAUVERON, (US)

(72) Inventor: Pierre Tauveron, Lyon (FR)

(21) Appl. No.: 14/387,183

(22) PCT Filed: Mar. 19, 2013
(86) PCT No.: PCT/FR2013/050592

§ 371 Date: Sep. 22, 2014

(30) Foreign Application Priority Data
Mar. 23, 2012 (FR) 1252598

(51) Int. Cl. G05B 15/02; H04L 29/08

(52) U.S. Cl. CPC G05B 15/02; H04L 67/10
USPC 700/12

(57) ABSTRACT

A method of processing tasks having at least one action server and at least one production server (SP) in which the action servers execute the control of the tasks in real time and in a direct and priority manner. This control is master and integrates all the changes of states that may have occurred on the internal elements of the system and on the external elements. The missing elements corresponding to these changes of state are classed into four categories: internal or external, deterministic or nondeterministic. For each of these categories a method of resolution is formulated at the level of the production server (SP). The system includes at least two data transmission buses: a ‘process’ bus (BP) linking the action servers and action terminals and desks (R1, R2, . . . ) as well as the production server (SP) and a video bus (BVDO) linking the production servers (SP), the production desks and terminals (P0, P1, . . . ) and the augmented reality server (SRA).

The present invention relates to an automated method for processing tasks, and a system for implementing the method. It is particularly applicable to automatic systems driving complex processes, that must be highly secure and/or to systems from which it is desirable to eliminate any reliance on a human decision.

In a very general way, automated systems for processing tasks are composed of assemblies or machines performing tasks for the needs of human activity. These tasks can be as varied as energy production, transport of individuals or goods, manufacturing of objects or complex assemblies and sub-assemblies, development of metals by mineral processing, etc. These machines or assemblies that make it possible to perform them may also be generally known as “equipment” or “production equipment” in the sense that it produces or performs something for which it was designed.

These tasks are for the most part performed in an automatic or partly automatic way by these assemblies and machines. To perform these tasks in a practical way these machines include actuators that replace the human hand and which are moved by mechanical, hydraulic, electrical and other systems. To control the correct execution of these tasks these machines are equipped with sensors of all kinds that constantly report on the state of the actuators and of the machine or of the assembly of machines. Automata and regulation systems make all these actuators operate by causing a certain number of actions to take place in sequence or by regulating these actions over time according to previously established setpoints.

In a great many cases the machines or the assembly of machines are placed in an environment that can have a certain influence on the correct operation of these machines, and in a certain number of cases the machines need this external environment to operate: for example an airplane needs the air outside for its engines to operate—as does a non-electric car—and to maintain a certain altitude. Very often this outside environment must also have parameters whose values are compatible with the operation of the equipment. Some of the sensors of the automation system are therefore devoted to the measurement of the environmental parameters required for the operation of the equipment.

The equipment includes so-called “real-time” control and regulation systems for tracking the variation of the environmental parameters.

Furthermore, all these systems have been designed so that humans can be constantly informed about the state of the equipment and also the state of performance of the various tasks, and where applicable intervene in the operation. This supervision and this intervention are therefore the basis for the design of most automation systems, due to the wish to always have a human presence in the equipment to ensure it is ultimately safeguarded in cases where an anomaly or dysfunction intervenes. Although an underground railway line suitably equipped with adequate sensors can be entirely automatic, there is to date only a single line on which the driver has been removed. It should also be noted that in the event of an incident it is the station personnel who intervene to resolve the fault, such as for example the incorrect closing of a door. Provision has not been made for the automation system to handle all incidents.

There still exists a human-machine interface composed of consoles containing screens for visualizing the state of the system and control devices such as push-buttons, keyboards, code-selection switches, hand levers and “joysticks” making it possible to act on the system or to modify regulations and setpoints. The regulators and controllers that act directly on the actuators are also known as action servers or computers. The consoles and control devices that take account of the actions of the operators and that produce the human-machine interface and the associated computers are also known as production terminals. In the most recent embodiments, all the action servers and computers are generally connected to a data transmission bus known as the “process bus” and communicate with each other by way of the latter. The regulators and action terminals are activated and deactivated via the production terminals. The control of the process is not a master control.

When an incident arises the system is very often limited to displaying the incident. In the most sophisticated cases a so-called “missing conditions” system also displays the states of certain members and/or external or internal conditions at the origin of the incident. There are also automation systems wherein the system will itself put a certain number of the actuators or certain parts of the equipment into a previously established so-called “safety” state or into a restart state allowing rebooting as if it was the first start. The assembly of the equipment is then supposed to be able to remain in the state for the time required for human intervention and repair without any disaster or destruction of the equipment or part of the equipment occurring; the automation that controls it is blocked at this stage.

But such a design supposes that an appropriate and very often rapid human intervention will make it possible to solve the problem. However, the control systems of the equipment are very complex nowadays and their supervision must be entrusted to highly qualified and very well trained high-level staff. This also supposes that the individuals that have to intervene will be doing so in optimal conditions, i.e. that they will be in full possession of their thought and decision-making processes, that their intervention will not for example take place at the end of a working day, when tiredness can diminish judgment.

However, recent examples have shown that reliance on a human decision has not made it possible to solve the problem and has sometimes led to disaster and the loss of the equipment and many lives. To demonstrate this, mention need only be made of the Chernobyl nuclear power plant, or the crash of the Air France Rio-Paris flight in June 2009. In the latter case it may be noted that the loss of speed measurements incurred as a “safeguard” the switching off of the automatic pilot and the switch over to manual command. This was followed by a series of poor decisions by the pilots (three in number) while the airplane remained controllable for several minutes.

Current methods for automating tasks to be performed by an item of equipment thus have their limits and exhibit the drawback of reliance on a human decision that is not always appropriate.

In a method according to the invention these drawbacks will be mitigated by reducing human intervention to zero if possible. To do this, the automation system handling the equipment must be studied in its environment, and, according to the method of the invention, on the one hand the set of parameters that are internal to the system and that must remain in a certain state for the assembly to operate will be considered, and on the other hand the set of parameters that are external to the system and which may have an influence on the correct operation of the equipment will be considered. Furthermore these two sets of parameters, which must be in a certain state for correct operation, can, for diverse reasons, change state, leading to a more or less considerable disturbance of the operation of the automaton handling the equipment. These sets of parameters define a sort of operational frame of reference of the process handling the equipment.

The parameters mentioned differ from the variables used for regulations and the setpoint values that relate to these variables. The same applies for actions of sequential type that use variable logic and operate according to logic equations. The events and parameters in question in the invention are, in particular, those of the auxiliary installations and of the environment that do however affect the correct operation of the equipment. By way of non-limiting example the operation of a pump in a hydraulic circuit or the tripping of a circuit-breaker of an electrical circuit are parameters internal to the system and not regulation variables.

The state changes of these parameters can be predictable in some cases, and it is then possible to predict this state change by having introduced into the automation system the desired modifications of the controls and regulations in each specific case of modification. These predictable changes are called deterministic. But other situations exist for which the changes are not predictable. It is however necessary to be able to react when these state changes have an influence on the operation of the equipment, or its safety. Such changes are called non-deterministic and, still according to the method of the invention, they are anticipated. The vocabulary used does not preclude the applicability of deterministic laws in the sense of mathematics and probabilities. According to the invention the probability of a state change of a parameter is not used for the development of the scenarios. The safety of the equipment is ensured by considering only the possible state change of such or such a parameter.

Thus the set of parameters having an influence on the correct operation of the equipment are classed into four categories as represented in the appended table. According to the method of the invention there exists in the automation system a methodology for programming a solution for each category. Still according to the invention, these are automata, controllers and action servers which execute these solutions in real time; they have been previously informed by the controllers and production servers, themselves liaising with the human-machine interfaces. In this respect the method of the invention is completely new since, as we have seen, conventional methods are restricted to setting safety or restart conditions and must await human intervention to continue controlling the equipment, which is done by way of the human-machine interface via the production terminals. A system for automating the operation of an item of equipment which has eliminated human intervention is nowadays called “passive”. The method of the invention is a method that makes it possible to obtain the passive safety of the automation systems, in other words “passivity”.

In a method for processing tasks of an automated system according to the invention, comprising at least one assembly of at least one action terminal forming at least one action server and an assembly of at least one production terminal comprising at least one production server, the action servers execute the control of the tasks in real time and in a direct and prioritized way, by integrating all the state changes that may have occurred on the elements internal to the system and likewise on the elements external to the system.

According to the method of the invention the control executed by the action servers in the control of the process is a master control that does not require any order issuing from the production servers. Still according to the invention, the handling of the external missing elements is performed, like the human-machine interfaces, from the consoles and production servers.

According to the method of the invention all the state changes of all the elements having an influence on the control of the process controlling the equipment are classed in the following way:

state changes of elements internal to the system and state changes of elements external to the system.

state changes following a deterministic law, state changes not following a deterministic law.

According to the method of the invention the missing elements that are internal to the system and following a deterministic law are listed, they are the subject of a scenario introduced into the production server and they are handled by a predictive systems analysis methodology; the missing elements that are external to the system and following a deterministic law are listed, they are the subject of a scenario introduced into the production server and they are handled by a predictive systems analysis methodology.

According to the method of the invention the missing elements that are internal to the system and not following a deterministic law are handled by collection of anticipative data, the missing elements that are external to the system and not following a deterministic law are handled according to the principle of anticipative augmented reality.

According to the invention all the data transmissions of the automated task processing system for implementing the method are performed by at least two buses. The consoles, controllers and action servers are linked to each other and linked to the production server by a first data transmission bus, the “process” bus and the consoles, computers and production servers are linked to each other by at least one second data transmission bus, the “video bus”.

But the invention will be better understood by the description of an embodiment.

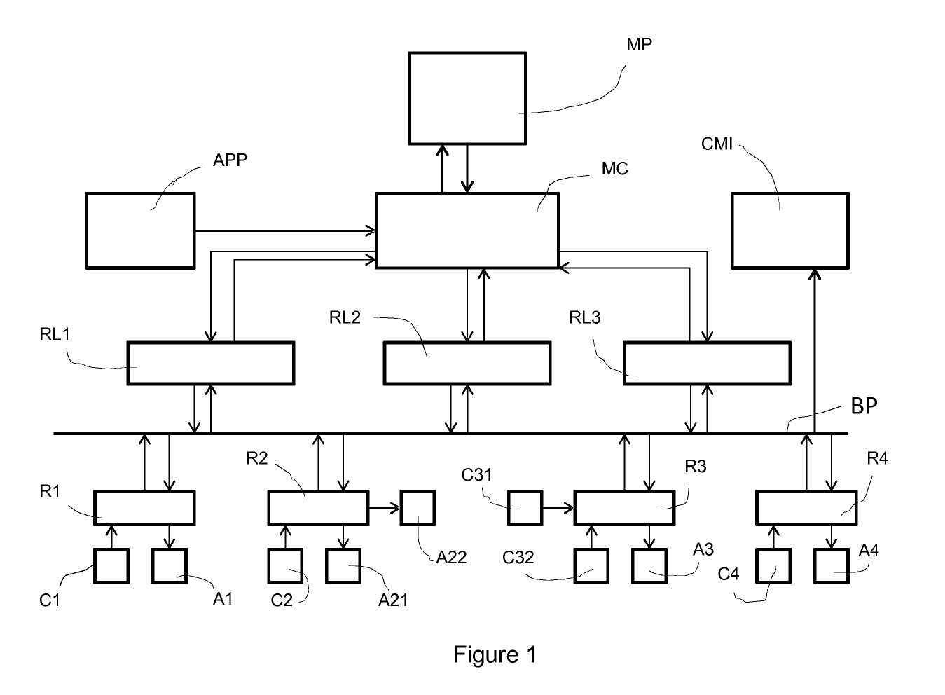

FIG. 1 represents a diagram of an automation system of the prior art.

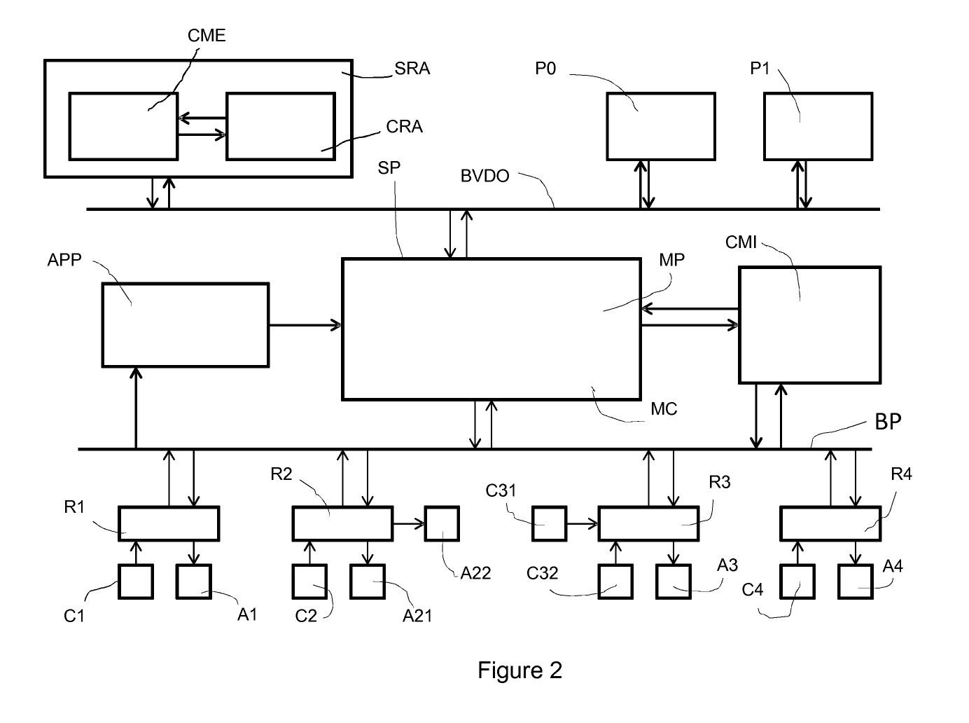

FIG. 2 represents a diagram of an automation system according to the invention.

In the prior art represented in FIG. 1, the automation of an item of equipment includes a certain number of actuators performing tasks A1, A2, . . . generally equipped with sensors C1, C2, . . . . These actuators execute the tasks when they are controlled by automata, controllers and/or regulators R1, R2, . . . . These commands can be the execution in sequence of the orders or the regulation of quantities (position, speed, temperature, pressure etc.) to previously established setpoints. In the most recent embodiments, and as shown in FIG. 1, all the regulators forming the action servers are connected to each other by a data transmission bus BP, here known as the ‘process’ bus.

It is possible that assembly sequences and/or regulations are needed for the operation of the equipment, in which case they are installed in regulation computers RL1, RL2, . . . which distribute the setpoints and the orders to the base controllers R1, R2, . . . via the “process” bus BP. The regulations RL1, RL2, . . . have received the necessary information originating from the equipment via this same ‘process’ bus. The behavior of the assembly of equipment may have been modeled in a mathematical model that may then participate in the development of the setpoints and the orders distributed to the actuators. Such a model is then installed on a master computer MC which dialogues with regulation computers using direct links between computers.

Finally, it is possible to install a production model MP on another computer, the latter then contains the general data and the features of the products that the equipment is to make. As we have seen in the introduction these diagrams can apply to very varied and diverse equipments and these general data may just as well be the quantity of steel to be cast by a steelworks and the shade of the metal as the number of passengers and the weight of baggage on an airplane. The computer containing the production model is directly connected to the master computer.

In certain cases the master model must undergo “training” and/or updating, i.e. its parameters must be calibrated on values based on real tasks executed by the equipment that will then replace or correct the theoretical values introduced when the installation is started. A computer is then installed for this training and updating APP in direct connection with the master model and which takes the averages and statistics needed for the evolution of the parameters.

In the most effective embodiments there is also provision for detecting at least some of the equipment parameters that would assume an unpredicted state or value in the control assembly no longer allowing correct and safe operation of the equipment. A specialized computer CMI is then installed to handle these situations. It can, in the most complicated situations, require the regulation servers to put the equipment into a chosen safety state or into a state allowing rebooting. It is also possible to install a kind of expert system that will indicate the conditions and states of the parameters that have provoked this safeguard or this restart. In all cases the system is blocked and the reboot requires the intervention of the operators, and for that the computers MP, MC, APP and CMI are equipped with the consoles and human-machine interfaces needed for these interventions and not represented in FIG. 1.

The method of the invention provides for avoiding human intervention and to do this it considers all the parameters having an influence on the operation of the equipment. In the method of the invention the control of the process is a master control, i.e. it is ensured by the action servers which dialog with each other. They do not need any activation and/or validation from the production servers. The method of the invention also describes a resolution methodology corresponding to the state changes of all these parameters. The appended table summarizes the classification of the parameters according to the method of the invention. The parameters are either internal or external to the system. Their state allows or does not allow correct operation of the equipment. The change of their state can be expected, and in this case the change of this state is part of the programming of the controller(s) using this parameter. The change, expected or otherwise, can be predictable or unpredictable. In the first case the parameter is classed as deterministic, in the second case it is classed as non-deterministic. In the summary table in the Appendix the upper half-cells relate to the automation methods of the prior art. It is observed that the regulation itself takes account of the deterministic internal parameters. These parameters are those exploited by the action servers which are informed by the sensors C1, C2, . . . .

However, the evolution of a deterministic internal parameter can be taken account of indirectly in a system of the prior art. For example it is possible to program the regulation of a quantity until the parameter reaches a certain limit. For example this can be the regulation of the injection of the engine of a motor vehicle with liquid fuel operating as a vehicle speed limitation. The vehicle speed will remain at the same speed whatever the effort required of the engine. The case of deterministic internal parameters is then processed in an indirect way by the most developed automation systems, at least for a certain number of internal parameters. When a state change impacts on another group of parameters no provision is made by the methods of the prior art. At the very most, this state change is visualized for the operators in a form known as “missing conditions” or “missing elements”. As regards the non-deterministic internal parameters it is then possible to have the restart or the safeguard of the system. As concerns the external parameters they are either totally ignored or appear as “missing element” if it was planned to take this parameter into account.

In a method of the invention all the parameters having an influence on the operation of the equipment are taken into account and a type of solution is developed by the method according to a methodology that depends on the group to which the parameter belongs. Thus the predictive systems analysis methodology, already partly implemented in the prior art, is extended systematically to all the deterministic parameters, internal and external. The handling of the disturbances incurred by the non-deterministic internal parameters relies on a methodology of collecting anticipative data. The handling of the disturbances induced by the non-deterministic external parameters uses a methodology relying on the principle of augmented reality, handled anticipatively. These different methodologies will be illustrated and explained further on. They are implemented using a structure of the automation system that is the subject of the invention illustrated in FIG. 2 and already partly described in the French patent FR 2 905 017 by the same inventor.

FIG. 2 represents a general diagram of an automation system for controlling an item of equipment for implementing the method of the invention. The action servers including the sensors C1, C2, C31, C32, . . . , the actuators A1, A21, A22, A3, . . . and the controllers and regulators R1, R2, . . . are all linked by a first “process” data transmission bus BP, and this part can be the same as in the diagram represented in FIG. 1. A general production server SP is connected to this bus. It includes the master model MC. This master model is the model integrating all the regulations and mathematical models already used in the diagram of the prior art, and all the predictive systems analysis handling the states of the deterministic internal and external parameters has also been integrated therein.

The production server SP also includes the production model MP which contains the model already described in the prior art and adapted to the production proposed for the equipment whatever the field of operation. In the method of the invention all the scenarios concerning the deterministic internal and external parameters are introduced. These scenarios were already at least partly present in the prior art where the internal parameters are concerned since it is from these parameters that the equipment was driven via the master model and the action server. In the method of the invention a list is established of all the internal parameters and all the deterministic external parameters having an influence on the operation of the equipment are therefore identified.

Still according to the invention, scenarios are written for all these parameters that are stored in the production model. The production server is also connected to at least one second data transmission bus BVDO named “video bus”, on which are connected the operator consoles and all the human-machine communication devices P0,P1, . . . . These interfaces thus make it possible to introduce scenarios, or to modify them, concerning all the deterministic internal and external parameters. By way of example, for the needs of equipment maintenance a so-called “manual” mode still exists which makes it possible to test all the functions of the equipment. These tests are performed from the operator consoles P0, P1, . . . and implement some of the scenarios concerning the deterministic internal parameters.

According to the previously established scenarios the master model elaborates the setpoints and reference points used by the action server according to the principle of predictive systems analysis. In the example of regulation of the speed of a motor vehicle the knowledge of a variation in the gradient of the road would, by way of a predictive systems analysis, allow the development of various scenarios meeting more complete general conditions than a simple regulation of speed, such as:

maintenance of the setpoint speed

change of the gear ratio in the event of a pronounced climb

observation of a speed limit

etc.

The training and/or updating of the master model is performed by a computer APP connected to the production server. This computer stores, in real time and/or as they happen, the execution data of the processes regulating the whole operation of the equipment, it takes the data deposited on the process bus and performs the statistics and processing of this data to develop the evolution of the master model parameters. At this stage all the functionalities already present in the architecture corresponding to the prior art have been relocated to a new architecture. Moreover, the deterministic missing elements have all been processed by the introduction of the scenarios into the production server and the introduction of the principle of predictive systems analysis into the regulations of the master model.

A computer CMI is connected to the process bus BP to perform a collection of the data and it has a direct connection to the production server. This computer CMI will process the non-deterministic internal missing elements by an anticipative method of data collection. The non-deterministic internal missing elements correspond to internal parameters, so they are known, and a certain number of them are already taken into account in the control of the method. In the method of the invention the computer CMI will therefore perform a collection of the data concerning all these parameters. What is not determined is the moment at which this parameter will assume a value or put itself into a state that will no longer allow the safe and correct operation of the equipment. It is possible to follow the evolution of the values of these parameters and to detect when a drift appears. At that moment one may very well set a new value to the parameter and have it taken into account by the master model in the same way as the updates.

This procedure may be compared by way of non-limiting example to the detection of the wear of a part in a mechanical device. There are many systems that make it possible to track parameters linked to the wear of mechanical parts, such as for example the operational equilibrium temperature of a ball bearing system or else its vibration signature. In these cases the supervised parameter assumes a stable value in the whole range of operation of the equipment, and this value begins to drift when the wear factor becomes high. In the method of the invention one may then, for example, set to determined values some parameters that will limit the rotation speed of the ball bearing system and thus ensure the operation and safety of the equipment until the worn part is replaced. The taking into account of the adequate value of the parameter(s) will be done by transmission from the computer CMI to the production server SP in the same way as the updates from the computer APP.

The non-deterministic external missing elements correspond to parameters external to the system, the state of which can assume a value affecting the operation of the equipment at any time, totally unpredictably. For example, an object falling on the road in the path of a school bus which is driven by a passive automaton according to the method of the invention.

These parameters will be processed according to the principle of anticipative augmented reality, a computer CME of the non-deterministic missing conditions associated with the interfaces and sensors of the augmented reality CRA, forming an augmented reality server SRA, will establish imaging of the whole equipment environment. The server SRA is connected to the video bus BVDO.

Augmented reality consists in superimposing on an image representing a real scene a virtual image representing a certain number of parameters concerning the same scene. This principle is now being studied for the purposes of maintaining certain equipment. One may thus present to a controller the superimposition of the inside of a reactor onto the outer view. But this does not only apply to three-dimensional geometric views. One may also form images, the dimensions of which are the various parameters having an influence on the operation of the equipment. One may thus superimpose a virtual thermal image onto the real image of the equipment. One may also, as a function of a certain number of parameters, create an anticipated virtual image on the state of the environment surrounding the equipment. Thus, the operational frame of reference of the process evolves, in real time with the conditions of the environment. According to the invention, this evolution is taken into account in the handling of the automaton.

In the example mentioned above, and according to the method of the invention, the fall of the object in front of the bus can be modeled and its trajectory predicted to determine the trajectory corrections and the commands to be applied to the bus to avoid the collision. The augmented reality server SRA thus dynamically develops new scenarios that it communicates to the production computer via the video bus BVDO. Thus the non-deterministic external missing elements are all processed by the server SRA and the computer CME according to the principle of anticipative augmented reality. In particular, it can develop new scenarios as needed and transmits them as such to the production model MP. Thus, the action server will continue to operate and to drive the equipment from these elements transmitted to the production server, without having to await the intervention of an operator and without putting itself in a blocked situation.

The processing of the non-deterministic missing conditions is now being made use of in aeronautics, for example. The collection of anticipative data is a form of the development of the ‘ACARS’ messages transmitted by aircraft, but they are not developed—or used—in real time and reserved for maintenance during the return of the craft to the ground. The process for avoiding collisions between aircraft ‘TCAS’ proceeds from a sort of anticipative augmented reality, but the use is limited to giving an alarm and the pilot is relied on to correct the trajectory of the craft. Scenarios are however developed since the order is given to one craft to climb and to the other to descend when both craft are at the same flight level and there is a collision risk.

In the method according to the invention the internal non-deterministic missing elements are processed by a computer CMI by collecting anticipative data, the result being developed in the form of a new parameter transmitted to the master model. The non-deterministic external missing elements are processed according to the principle of anticipative augmented reality by a dedicated server SRA and computer CME connected to the video bus. They are introduced into the production model as new scenarios, to be processed in real time by the action server.

In all cases the action server(s) ensure the control of the equipment in real time and communicate with each other via the process bus BP without ever finding themselves in a blocked situation awaiting human intervention.

The examples and the description of the invention given above are not limiting. It is for example possible to introduce into the automaton architecture a second video bus, for example dedicated to the transmission of the augmented reality data.

Similarly, the examples developed in the description are not limiting to the invention. As has been stated, the equipment can be energy production equipment such as a nuclear power plant or equipment for producing highly dangerous raw materials of SEVESO class.

But the method of the invention can also be applied to other equipment that could advantageously be automated for safety reasons, such as for example financial systems and “high-frequency trading”. Experience has shown that these devices under human control can fall prey to runaway situations and lead to the financial disasters the world has known.

The reference points featuring on the diagrams, in the text and the claims serve to provide a better understanding of the invention and are in no way limiting thereto.

### APPENDIX

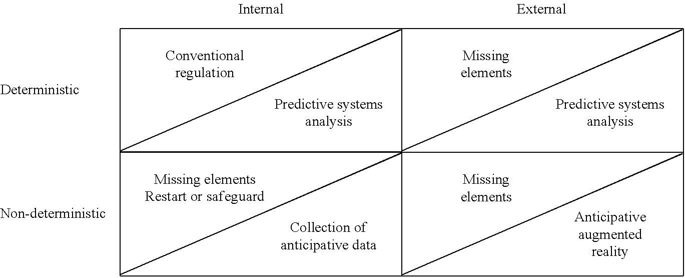

1. Method for processing the tasks of an automated system comprising at least one assembly of at least one action terminal forming at least one action server capable of executing task control in real time and in a direct and prioritized way by implementing at least one regulation of quantities to pre-established setpoints making use of the internal parameters of the system that are informed by sensors, wherein:
on the one hand, the set of the parameters internal to the system are considered and, on the other hand, the set of the parameters external to the system liable to have an influence on the operation of the system, of which at least some of said parameters are liable to assume a state affecting the operation of the system, are considered,
all the state changes liable to occur on all said parameters internal to the system and on all said parameters external to the system are taken into account and a methodology of resolution is developed corresponding to said state changes according to whether these state changes are predictable or not, suitable for allowing the real-time control of the system by said action server to continue without it finding itself in a blocked situation awaiting human intervention.

2. Method for processing the tasks of an automated system according to claim 1, wherein all the parameters internal and external to the system the state change of which is predictable are listed and in that the state changes of said parameters internal and external to the system the state change of which is predictable are processed according to pre-established scenarios introduced into said task control.

3. Method for processing the tasks of an automated system according to claim 1, wherein the state changes of the parameters internal to the system the state change of which is not predictable are processed by performing a collection of data concerning all said parameters and by taking account of the evolution of the values of said parameters in said task control.

4. Method for processing the tasks of an automated system according to claim 1, wherein the state changes of the parameters external to the system the state change of which is not predictable are processed by creating a virtual image anticipated from the state of the environment surrounding the system as a function of a certain number of said parameters, consisting in superimposing on an image representing a real scene of said environment a virtual image representing at least some of said parameters concerning said scene, and by taking account of an evolution of an operational frame of reference of the system based on said anticipated virtual image.

5. Method for processing the tasks of an automated system according to claim 4, wherein the taking account of the evolution of the operational frame of reference of the system is performed by the development of new scenarios.

6. Automated system for processing tasks for implementing the method according to claim 1, comprising an assembly of at least one production terminal, at least one assembly of at least one action terminal forming at least one action server and a production server, wherein said production server is linked to the assembly of at least one action terminal by way of a first data transmission bus and in that said at least one production terminal is linked to the production server by way of a second data transmission bus.

7. System according to claim 6, further comprising an augmented reality server connected to said second data transmission bus.
